(19) United States
(12) Patent Application Publication
(10) Pub. No.: US 2013/0133780 A1
(43) Pub. Date: May 30, 2013

(54) INSTALLATION FOR FILLING GAS CYLINDERS WITH AN ANGULAR GAS-DISTRIBUTION DEVICE

(71) Applicants: Pierre De Villemeur, Louveciennes (FR); Celso Zerbinatti, Buc (FR); Joël Samirant, Rosny sous Bois (FR)

(72) Inventors: Pierre De Villemeur, Louveciennes (FR); Celso Zerbinatti, Buc (FR); Joël Samirant, Rosny sous Bois (FR)

(73) Assignees: AIR LIQUIDE SANTE (INTERNATIONAL), PARIS (FR); L'AIR LIQUIDE, SOCIETE ANONYME POUR I'ETUDE ET I'EXPLOITATION DES PROCEDES GEORGES CLAUDE, Paris (FR)

(21) Appl. No.: 13/479,750

(22) Filed: May 24, 2012

(30) Foreign Application Priority Data
Jun. 8, 2011 (FR) 1154975

(51) Int. Cl. F17C 5/06

(52) U.S. Cl. CPC F17C 5/06
USPC 141/4; 141/237

(57) ABSTRACT

The invention relates to an installation for filling gas containers (5) comprising at least one gas-container (5) filling system (2) comprising at least one gas-distribution device and connection means allowing the said device (1) to be connected fluidically to several containers (5) so as to fill the said containers (5) simultaneously with gas, for example a mixture of NO and of nitrogen. The gas-distribution device comprises a main body (1) with an internal gas-distribution chamber (3), a gas inlet orifice (11) fluidically communicating with the internal chamber (3) so as to allow gas to enter the said internal chamber (3) via the said inlet orifice (11), and several outlet orifices (12) fluidically communicating with the internal chamber (3) so as to allow gas to be discharged from the said internal chamber (3) via the said outlet orifices (12). The outlet orifices (12) are angularly distributed in the internal chamber (3).

### CROSS REFERENCE TO RELATED APPLICATIONS

This application claims the benefit of priority under 35 U.S.C. §119 (a) and (b) to French Application No. 1154975 filed Jun. 8, 2011, the entire contents of which are incorporated herein by reference.

### BACKGROUND

The invention relates to an installation for filling gas cylinders with a gas-distribution device with angularly distributed outlets for supplying gas to a plurality of gas cylinders that are to be filled, and to a method of packaging a gaseous mixture, particularly mixtures of NO/N₂ implementing such an installation for filling gas cylinders.

Gaseous NO/N₂ mixtures are commonly used to treat pulmonary vasoconstrictions in adults or children, particularly in newborn infants suffering from primary pulmonary hypertension or in patients who have undergone cardiac surgery.

These NO/N₂ mixtures are conventionally packaged into steel gas cylinders. Typically, these cylinders contain, by volume, 100 to 1000 ppm of NO, the remainder being nitrogen (N₂). These cylinders usually have a water capacity of 2 to 50 litres which means that a total charge of as much as 15 m³ of NO/N₂ mixture can be admitted to them.

The packaging of these mixtures, which means the filling of cylinders with these mixtures, is done at gas filling centres using one or more filling systems.

As illustrated in FIG. 1, in each filling system 21, the cylinders 25 that are to be filled are lined up and connected, via hoses 24, to a gas-distribution chamber 23 supplied with gas under pressure by a gas supply line 22. The flow of gas through the line 22 is controlled by one or more valves 27 and, likewise, the transmission of gas from the distribution chamber 25 to the hoses 24 is controlled by valves 26 which are controlled by a control system. A purge line 29, fitted with a valve 8, allows the gas contained in the distribution chamber 23 to be discharged to the atmosphere, for example during an operation of gaseous purging of the cylinders 25.

Such systems are not ideal when the gas cylinders have to be filled with gaseous mixtures that contain several ingredients.

This is because it has been found in practice that the gaseous mixtures obtained were often nonhomogeneous, which means to say that the cylinders contained quantities of gaseous NO/N₂ mixture that varied from one cylinder to another.

The problem therefore is to propose an installation for filling gas containers and a packaging method which are improved and allow several gas cylinders to be filled simultaneously while at the same time ensuring good precision and better reliability of the gaseous mixture thus produced and packaged, i.e. allowing several gas cylinders of one system to be filled with a gaseous mixture in such a way as to obtain filled cylinders containing a gaseous-ingredients concentration which is identical from one cylinder to another.

### SUMMARY

The solution of the invention is therefore an installation for filling gas containers comprising at least one gas-container filling system comprising at least one gas-distribution device and connection means allowing the said gas-distribution device to be connected fluidically to several containers so as to fill the said containers simultaneously with gas, the gas-distribution device comprising a main body comprising an internal gas-distribution chamber, a gas inlet orifice fluidically communicating with the internal chamber so as to allow gas to enter the said internal chamber via the said inlet orifice, and several outlet orifices fluidically communicating with the internal chamber so as to allow gas to be discharged from the said internal chamber via the said outlet orifices, characterized in that the outlet orifices are angularly distributed in the internal chamber.

Depending on circumstance, the installation of the invention may have one or more of the following technical features:
The internal chamber comprises an internal peripheral wall, the outlet orifices being arranged within the said peripheral wall, preferably the internal chamber comprises a peripheral wall of circular section, which means to say is at least partly cylindrical in shape.
The internal chamber comprises an upper wall forming a roof into which the gas inlet orifice opens, preferably the gas inlet orifice is positioned at the centre of the upper wall.
The axis (AA) of one given first outlet orifice is angularly offset from the axis (BB) of a second outlet orifice which is situated immediately beside the said first outlet orifice by an angle of between 10° and 60°, preferably between 15° and 40°.
The outlet orifices are distributed, while at the same time being angularly spaced equal distances apart, over the entire internal periphery of the peripheral wall of the internal chamber.
The gas-distribution device comprises an inlet connector positioned in the region of the inlet orifice and projecting out from the body.
Each outlet orifice is fluidically connected to an outlet connector by a line portion.
The gas-distribution device comprises from 6 to 25, typically 10 to 20, outlet orifices.
The connecting means comprise hoses.
At least one pipe carrying gas is connected to the inlet connector of the gas-distribution device.
It comprises several controlled gas-container packaging systems commanded and controlled by control means, such as a computer, a control desk or the like.
It comprises a weighing machine used to weigh the cylinders and/or to make spot-checks on the final gaseous mixture.
It comprises at least two gas-container packaging systems each equipped with a gas-distribution device according to the invention.
The said at least one gas-distribution device of the said at least one gas-container packaging system is fluidically connected to one or more sources of gas containing NO.
The said at least one gas-distribution device is fluidically connected firstly to a source of a premixture containing a premix of NO and of nitrogen and secondly to a source of nitrogen containing nitrogen.
The said at least one gas-distribution device is fluidically connected to at least one liquid nitrogen reservoir fluidically connected to at least one heat exchanger or to a vaporizer to convert the liquid nitrogen into gaseous nitrogen.
The containers, particularly gas cylinders, are set out in a circular arc around the said at least one gas-distribution device when they are fluidically connected to the said at least one gas-distribution device.

Furthermore, the invention also relates to a method for packaging a gas or gaseous mixture into several containers comprising the simultaneous introduction into the said containers of a gas or of a gaseous mixture by means of a distribution device or of an installation according to the invention.

Depending on circumstance, the method of the invention may comprise one or more of the following technical features:
At the end of filling, the pressure in each container is between 2 and 700 bar, and preferably at least 150 bar.
The gaseous mixture is formed of NO and of N₂, preferably it contains an NO content less than or equal to 40% by volume, preferably it contains an NO content less than or equal to 5% by volume.
The gaseous NO/N₂ mixture contains an NO content less than or equal to 1000 ppm by volume, preferably of between 200 and 1000 ppm by volume, and more preferably still from of between 200 and 800 ppm by volume.
The containers are gas cylinders.
The containers have bodies made of steel, aluminium or an aluminium alloy.
Before being filled with gas, the containers are subjected to a gaseous rinsing step during which nitrogen is admitted to each container; a purge step during which the internal volume of each container is placed in fluidic communication with the ambient atmosphere; and/or an evacuation step during which the internal volume of each container is placed under depression (i.e. under a pressure <1 atm).

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

The invention will now be better understood by virtue of the description given hereinafter with reference to the attached figures, among which:

FIG. 1 is a filling installation according to the prior art,

FIG. 2 is a cross-sectional diagram of one embodiment of a distribution device of a gas container filling installation according to the invention,

FIG. 3 is a side view of the device of FIG. 2,

FIG. 4 is a view of the device of FIG. 3 from above, and

FIG. 5 is a schematic view from above of one embodiment of a filling installation according to the invention.

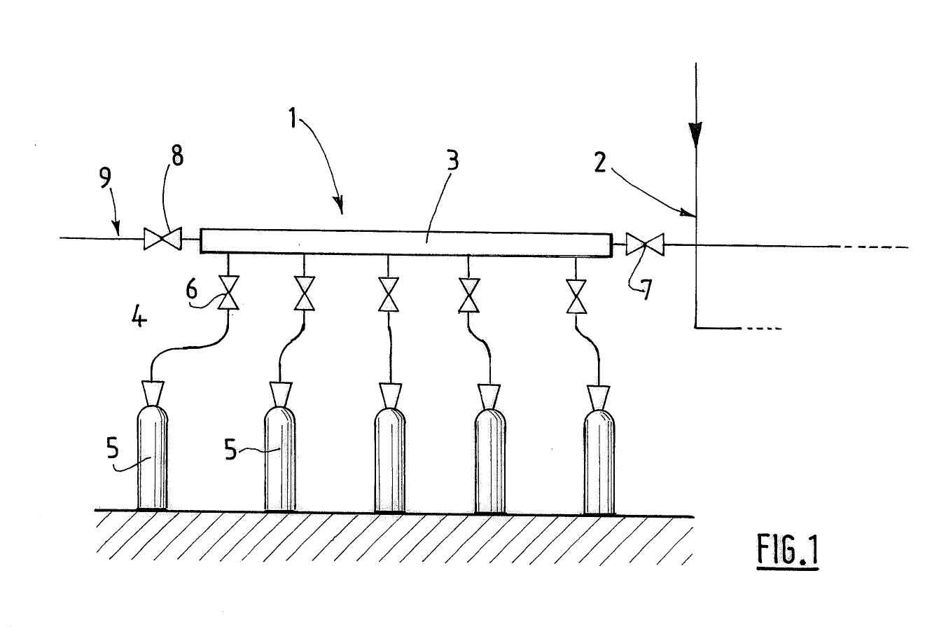

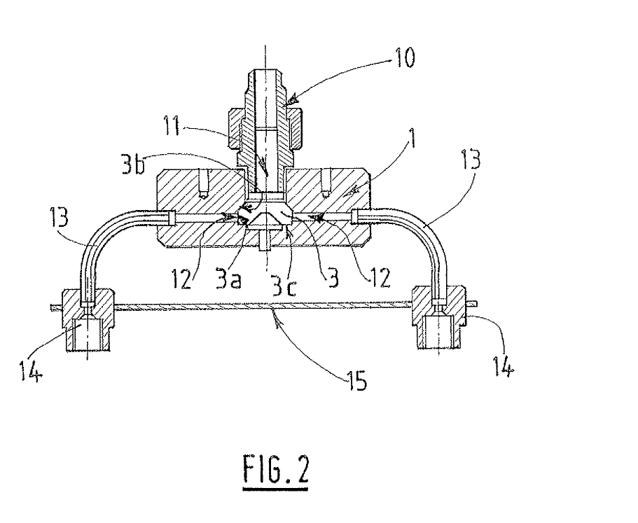

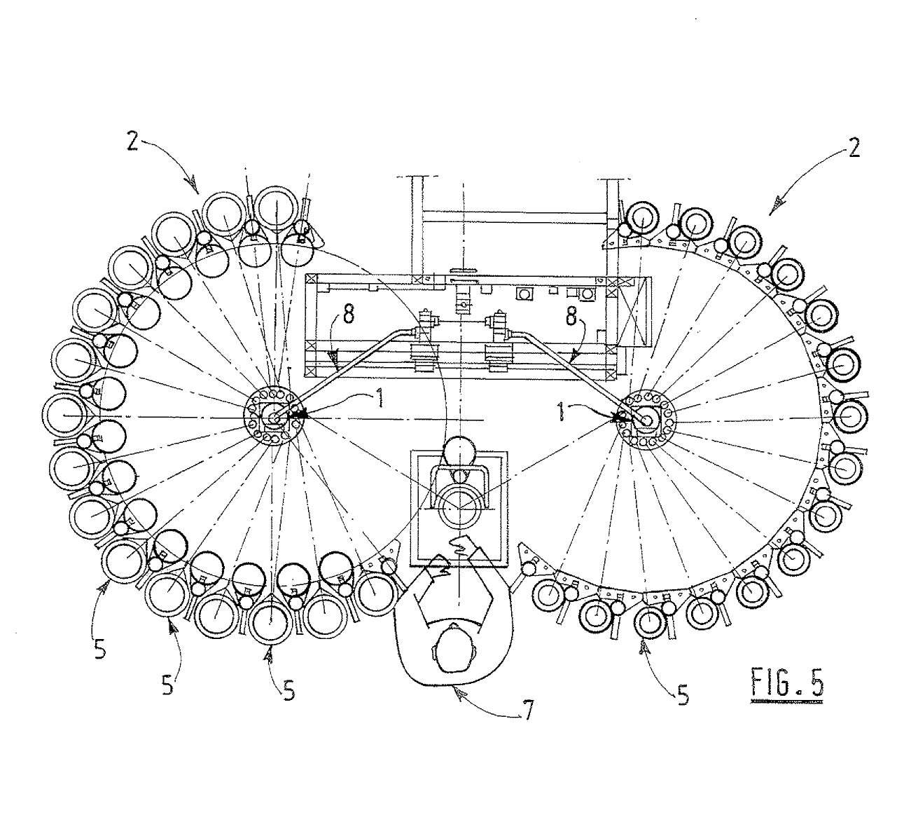

FIGS. 2 to 4 schematically depict one embodiment of a gas-distribution device 1 designed to be implemented on a system 2 for filling gas containers, i.e. gas cylinders, of a gas-container 5 filling installation according to the invention, comprising connecting means such as hoses allowing several containers 5, typically 10 to 20 gas cylinders or carboys to be filled at the same time, as illustrated in FIG. 5.

### DESCRIPTION OF PREFERRED EMBODIMENTS

The gas-distribution device comprises a main body 1 comprising an internal gas-distribution chamber 3. This internal chamber 3 is delimited by an internal peripheral wall 3a surmounted by an upper wall forming a roof 3b and closed at the bottom by a lower wall forming a bottom 3c.

For preference, the internal peripheral wall 3a has a cylindrical shape, i.e. a circular cross section.

A gas inlet orifice 11 fluidically communicating with the internal chamber 3 is formed through the upper wall or roof 3b of the body 1.

The inlet orifice 11 is a single orifice which opens into the roof 3b of the internal chamber 3 and allows gas to be admitted to the said internal chamber 3. For preference, the inlet orifice 11 is situated at the centre of the roof 3b so as to distribute the gas homogeneously and equally through the internal chamber 3.

A gas inlet connector 10, i.e. a connection for connecting a single gas carrying line 8, is arranged in the inlet orifice 11, protruding out from the body 1. This supply line 8 is fed, in the conventional way, from one or more gas sources, such as reservoirs of gas or gaseous mixture.

In the case of NO/N₂ mixtures that are to be packaged into the containers 5, the supply line 8 is fed, firstly, from a source of NO/N₂ premix, typically mixtures containing under 40% NO, the remainder being nitrogen, for example containing 4% of NO by volume in nitrogen and, secondly, from a source of nitrogen, for example a reservoir of liquid nitrogen fluidically connected to a heat exchanger or a vaporizer to convert the liquid nitrogen into gaseous nitrogen so that the final NO/N₂ mixture can be created at the desired concentration by diluting the (for example 4%) NO/N₂ mixture with nitrogen.

Moreover, several outlet orifices 12 fluidically communicating with the inside of the internal chamber 3 are pierced or formed through the internal peripheral wall 3a of the chamber 3 so as to allow gas to be discharged from the said internal chamber 3 via the said outlet orifices 12, to pipes 13 or the like fluidically connected to the containers 5 that are to be filled.

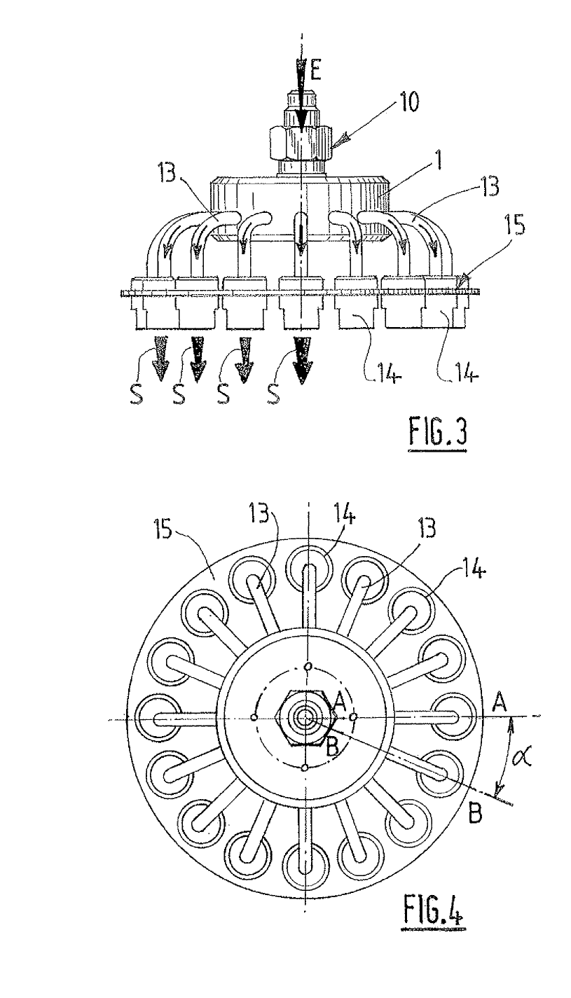

In other words, the gas entering the distribution chamber 3 via the gas inlet connector 10 (arrow E in FIG. 3) and therefore entering the inlet orifice 11, is then distributed between the various outlet orifices 12 and passes through them, leaving the distribution chamber 3 (arrows S in FIG. 3) and is then carried via the gas pipes 13 equipped with outlet connectors 14, and then via hoses, as far as the containers 5 that are to be filled.

According to the invention, the outlet orifices 12 are angularly distributed in the internal chamber 3, i.e. are situated equal distances apart while being oriented radially towards the inside of the chamber 3 as illustrated in FIG. 2.

More specifically, the axis AA of a given first outlet orifice 12 is angularly offset from the axis BB of a second outlet orifice 12 which is situated immediately next to the said first outlet orifice 12 by an angle α of between 10° and 60°, preferably between 15° and 40°. For preference, the outlet orifices 12 are distributed, while at the same time being angularly spaced at equal distances apart, over the entire internal periphery of the peripheral wall 3a of the internal chamber 3.

It then follows that the axis of one orifice 12 considered makes an angle α of approximately 360°/x with the respective axes of the two orifices situated on either side of the orifice considered, where x corresponds to the total number of orifices 12 arranged on the internal periphery of the peripheral wall 3a of the internal chamber 3. Thus, for 16 outlet orifices 12 for example, the angle α between orifices is 360°/16, i.e. approximately 22.5°, as illustrated in FIG. 4.

Usually, approximately 6 to 25 outlet orifices 12, preferably 10 to 20 orifices 12, are provided so that up to 25 gas containers 5 arranged on the one same system 2 and fed from the gas-distribution device of the invention can be filled simultaneously using flexible hoses.

For preference, the outlet connectors 14 are connected or held together by a peripheral structure 15, such as a circular ring or the like as illustrated in FIGS. 2 to 4.

FIG. 5 schematically depicts a filling installation, which means an installation for packaging gas in containers 5, namely gas cylinders, according to the invention, which installation comprises two systems 2 for filling gas containers 5 these operating independently of one another.

Each system 2 is fed with gas by a gas-distribution device 1 according to FIGS. 2 to 4 which is specific to it, each gas-distribution device 1 itself being fed by a gas supply line 8, as explained above.

Connecting means, i.e. hoses or the like, allow the said device 1 to be fluidically connected to gas containers 5 so as to fill them simultaneously with gas passing through the gas-distribution device 1 of the filling installation of the invention.

As may be seen in FIG. 5, the cylinders 5 that are to be filled are set out, not in a line but in a circular arc, which allows a considerable space saving on the filling site.

The filling operations are commanded and controlled by an operator 7 using control means, such as a computer, a control desk or the like. These control means are used to fix or adjust the parameters of the various stages of the filling method, such as the duration, pressure, etc., and to monitor its progress and store the operations and parameters.

A weighing machine is used to weight the cylinders and/or to make spot checks on the final gaseous mixture.

The filling and packaging device and installation according to the present invention allow several gas cylinders 5 to be filled simultaneously while at the same time ensuring good accuracy and improved reliability of the gaseous mixture thus produced and packaged, i.e. allow several gas cylinders 5 from one or more systems 2 to be filled with a gaseous mixture in such a way as to obtain filled cylinders 5 containing a gaseous ingredients concentration which is identical from one cylinder 5 to another.

This makes it possible to produce with great precision gaseous mixtures, particularly NO/N₂ mixtures containing an NO content less than or equal to 5% by volume, particularly mixtures containing under 1000 ppm of NO by volume, the remainder being nitrogen, which mixtures are packaged at a pressure of between 2 and 700 bar, preferably of at least 150 bar, in gas cylinders with a body made of steel, aluminium or an aluminium alloy.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An installation for filling gas containers (5) comprising at least one gas-container (5) filling system (2) comprising at least one gas-distribution device (1) and a fluid connection configured to fluidically connect the gas-distribution device (1) to several containers (5) so as to be capable of filling the containers (5) simultaneously with a gas, the gas-distribution device (1) comprising a main body comprising:
an internal gas-distribution chamber (3),
a gas inlet orifice (11) fluidically communicating with the internal gas-distribution chamber (3) and adapted to allow the gas to enter the internal chamber (3) via the inlet orifice (11), and
two or more outlet orifices (12) fluidically communicating with the internal chamber (3) and configured to allow the gas to be discharged from the internal chamber (3) via the outlet orifices (12),
wherein the outlet orifices (12) are angularly distributed in the internal chamber (3).

2. The installation of claim 1, wherein the internal chamber (3) comprises an internal peripheral wall (3a), the outlet orifices (12) being arranged within the internal peripheral wall (3a).

3. The installation of claim 2, wherein the internal chamber (3) comprises an internal peripheral wall (3a) which is at least partly cylindrical in shape.

4. The installation of claim 1, wherein the internal chamber (3) comprises an upper wall forming a roof (3b) into which the gas inlet orifice (11) opens.

5. The installation of claim 1, wherein an axis (AA) of a first outlet orifice (12) is angularly offset from an axis (BB) of an adjacent second outlet orifice (12) by an angle (α) of between 10° and 60°.

6. The installation of claim 5 wherein the angle is between 15° and 40°.

7. The installation of claim 2, wherein the outlet orifices (12) are both a) distributed over the entire internal periphery of the internal peripheral wall (3a) of the internal chamber (3) and b) angularly spaced equal distances apart.

8. The installation of claim 1, wherein the gas-distribution device (1) comprises an inlet connector (10) positioned in a region of the inlet orifice (11) and projecting out from the gas-distribution device (1).

9. The installation of claim 1, wherein each outlet orifice (12) is fluidically connected to an outlet connector (14) by a line portion (13).

10. The installation of claim 1, wherein the gas-distribution device (1) comprises from 6 to 25 outlet orifices (12).

11. The installation of claim 1, wherein the at least one gas-distribution device (1) is fluidically connected to one or more sources of gas containing NO.

12. The installation of claim 11, wherein the gas containing NO is a premixture of NO and of nitrogen.

13. The installation of claim 1, wherein the at least one gas-distribution device (1) is fluidically connected to a heat exchanger or to a vaporizer fluidically connected to liquid nitrogen reservoir, the heat exchanger or vaporizer adapted to convert the liquid nitrogen into gaseous nitrogen.

14. The installation of claim 8, wherein at least one pipe (8) carrying the gas is fluidically connected to the inlet connector (10) of the gas-distribution device.

15. The installation of claim 1, wherein the containers (5) are set out in a circular arc around the at least one gas-distribution device (1) when they are fluidically connected to the at least one gas-distribution device (1).

16. A method for packaging a gas or gaseous mixture into several containers (5) comprising the step of simultaneously introducing into the containers (5) the gas or gaseous mixture from the installation of claim 1.

17. The method of claim 16, wherein at the end of introducing, a gas pressure in each container is between 2 and 700 bar and/or a gaseous mixture is formed of NO and of N₂.

18. The method of claim 16, wherein the containers (5) are gas cylinders.
